(19) United States
(12) Patent Application Publication
(10) Pub. No.: US 2008/0223220 A1
(43) Pub. Date: Sep. 18, 2008

(54) POPCORN MAKER

(76) Inventor: Zheng Peng, Ypsilanti, MI (US)

Correspondence Address: ZHAOXIA XU, 4694 SYCAMORE DR., YPSILANTI, MI, 48197, US

(21) Appl. No.: 11/687,640

(22) Filed: Mar. 17, 2007

(51) Int. Cl. A23L 1/18

(52) U.S. Cl. 99/323.5

(57) ABSTRACT

A popcorn maker (100). Popcorn maker (100) comprises a container (102) for holding and popping corn kernels, a popping bowl (104) installed on top of container (102) for holding and serving popped corns, a lid (105) installed on top of bowl (104) for closing the open top of bowl (104) to avoid splashing, a stirrer (114) installed inside container (102) for stirring corn kernels, a co-rotation prevention member (118) installed inside container (102) on the sidewall for preventing corn kernels from co-rotating with stirrer (114), as stirrer (114) rotates, a heating tube (116) disposed underneath container (102) for heating corn kernels, a base support (112) disposed underneath container (102) for supporting container (102), a support member (110) installed on the bottom of container (102) for adapting container (102) to stand in position on base support (112), and a motor (124) installed inside base support (112) and coupled with stirrer (114) for driving stirrer (114).

### TECHNICAL FIELD AND INDUSTRIAL APPLICABILITY OF THE INVENTION

This invention generally relates to popcorn makers. More specifically, this invention relates to popcorn makers that can be used for making regular popcorn, kettle or caramel corns, and some other treats.

### BACKGROUND OF THE INVENTION

Americans consume 17 billion quarts of popped popcorn annually or 54 quarts per man, woman and child. It is one of the most wholesome and economical foods available. Approximately 70 percent is eaten in home, home popped and pre-popped. Un-popped popcorn accounts for approximately 90 percent of sales for home consumption.

Popcorn-making devices of various types are known in the art and are used for popping kernels of corn into popcorn. There are various methods for heating the corn kernels, with various ingredients added in the popcorn-making process. However, other known devices do not enable a user to make caramel or kettle corns. It is highly inconvenient for consumers to make these special treats at home using products currently on the market. In addition, products currently on the market are specifically for use of making popcorn. Consumers desire a popcorn maker that can also be used for many other applications to save kitchen space.

Therefore, it remains desirable to provide a popcorn maker that enables a user to make caramel or kettle corns at home with ease, in addition of making regular popcorn, and that is convenient to use and less expensive to manufacture. Also, it remains desirable to provide a popcorn maker that can be used for other applications, such as, deserts, chocolates, sauces, etc.

### BRIEF SUMMARY OF THE INVENTION

Accordingly, the present invention is a popcorn maker. This popcorn maker comprises a container for holding and popping corn kernels, a popping bowl installed on top of the container for holding and serving popped corns, a lid for closing up the open top of the popping bowl, a support member fixedly engaged with the lower portion of the container and extended downward to a predetermined distance for adapting the container to sit on a base support or a horizontal counter top, a stirrer installed inside the container for stirring corn kernels, a heating tube installed on the bottom of the container for heating corn kernels, a co-rotation prevention member installed on the sidewall of the container for preventing corn kernels from co-rotating with the stirrer, as the stirrer rotates, and a motor installed inside the base support and removably coupled with the stirrer for driving the stirrer.

Accordingly, the followings are some of the objects, features, and advantages of the present invention.

It is an object of the present invention to provide a popcorn maker that enable a user to make caramel or kettle corns at home with ease, in addition of being used for making regular popcorn.

It is another object of the present invention to provide a popcorn maker that is simple to use, less bulky to save kitchen space, and less expensive to manufacture.

it is a feature of the present invention that a popping bowl is installed on top of the container. This bowl together with the container is provided for popping-and-serving popcorn and is removable for cleaning after use, dishwasher safe.

It is another feature of the present invention that this popcorn maker includes a support member for supporting the container. The upper end of the support member is fixedly engaged with the periphery of the bottom portion of the container and the lower end of the support member extends downward to a predetermined distance for adapting the container to stand on a base support or on a horizontal surface.

It is a further more feature of the present invention that the heating tube is fixedly installed on the bottom of the container to save some cost associated with a separate heater having a thermal diffusion plate, which requires significant amount of material and space. By directly installing the heating tube on the bottom of the container heating efficiency is significantly enhanced.

It is a still further more feature of the present invention that a thermostat is removably engaged with the bottom of the container for detecting and limiting the temperature and controlling the heating tube.

It is an advantage of the present invention that the popcorn maker can be used for many other applications, such as deserts, chocolates, sauces, etc.

It is another advantage of the present invention that the popcorn maker is highly compact to save space and material cost.

Further more features and advantages of the present invention will be readily appreciated, as the same becomes better understood after reading the subsequent description when considered in connection with the non-limiting accompanying drawings.

### BRIEF DESCRIPTION OF THE DRAWINGS

FIG. 1 illustrates a cross-sectional view of an embodiment of the present invention, a popcorn maker 100.

FIG. 2 illustrates a bottom view of container 102.

FIG. 3 illustrates a top view of base support 112.

FIG. 4 illustrates an exploded cross-sectional view of seal device 130 and coupling device 132.

FIG. 5 illustrates another cross-sectional view of popcorn maker 100.

FIG. 6 illustrates a cross-sectional view of another embodiment of the present invention, a popcorn maker 200.

FIG. 7 illustrates a side view of coupling device 208 for popcorn maker 200.

FIG. 8 illustrates a top view of coupling device 208 for popcorn maker 200.

### DETAILED DESCRIPTION OF THE INVENTION

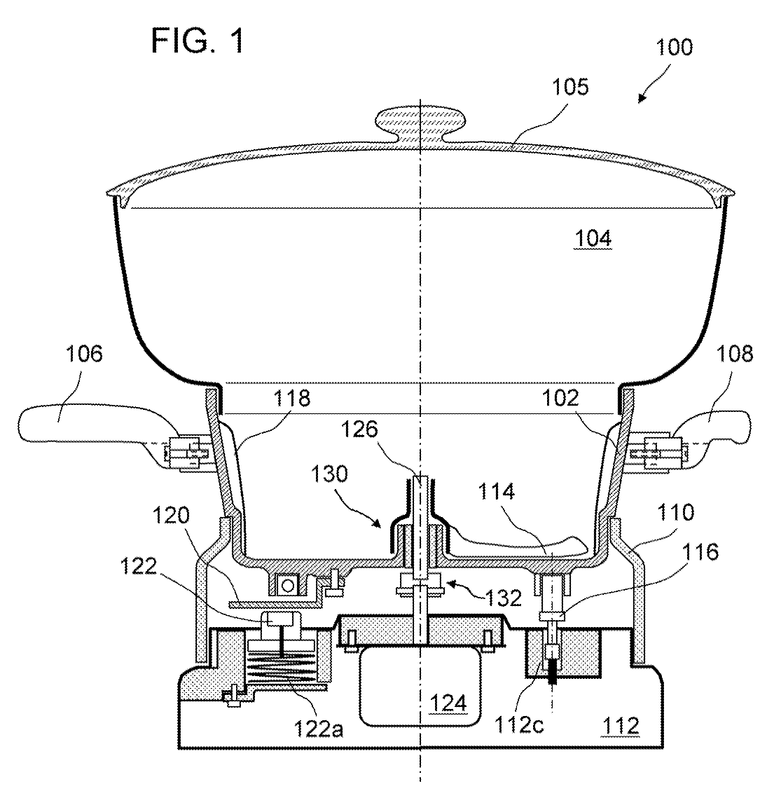

Reference is made to FIG. 1, which illustrates a cross-sectional view of an embodiment of the present invention, a popcorn maker 100.

A container 102, having an open top, a sidewall, and a central aperture on the bottom, is provided for popping corn kernels. The sidewall of container 102 is slightly tapered with a larger diameter on the top and a smaller diameter on the bottom. Container 102 is made of a metal material of high thermal conductivity and is, preferably, coated with a non-stick material.

A popping bowl 104, installed on top of container 102, is provided for containing corn kernels while they are being popped and to act as a serving bowl for the popped kernels during consumption. Bowl 104 has an open bottom fitting with the open top of container 102 and an open top for serving popped corns. Bowl 104 has a tapered cross-section with a larger diameter facing upward. Bowl 104 can be made from plastic or any other material sufficient to hold the popcorn and withstand the heat necessary to pop the kernels. Preferably, bowl 104 is transparent so that a user may see the kernels as they are being popped. However, bowl 104 can also be opaque or non-transparent. Many other designs or configurations of bowl 104 are readily applicable, such as a bowl having a closed top and an open bottom, as known to those skilled in the art.

A lid 105 is provided for closing up the open top of bowl 104, such that oil or other food splashing is contained within bowl 104. Lid 105 is, preferably, made of a transparent material.

A grasp handle 106 and a lift handle 108 are fixedly installed on the upper portion of the sidewall of container 102 for use of handling container 102 and bowl 104.

A support member 110, having a generally tapered hollow cylindrical configuration, is provided for supporting container 102. The upper end of support member 110 is fixedly engaged with the periphery of the bottom portion of container 102 and the lower end of support member 110 is extended downward to a predetermined distance, such that container 102 is adapted to stand on a base support 112 or on a horizontal countertop. Support member 110 is provided also for enclosing the space underneath the bottom of container 102 into a protected space. Some windows or slots may be opened on support member 110 for venting heat, etc.

A stirrer 114, removably installed inside container 102, is provided for stirring corn kernels. The clearance between the lower edge of stirrer 114 and the bottom of container 102 is minimized for better stirring performance. The profile of stirrer 114 is optimized for minimizing stirring resistance, such that less motor power is required to drive stirrer 114; which saves some cost on motors.

An electrical heating tube 116, having a generally circular configuration, is provided for heating corn kernels disposed inside container 102. Heating tube 116 is fixedly installed on the outside surface of the bottom of container 102, inserted into a groove formed on the bottom of container 102, and disposed close to the periphery with a predetermined distance. Heating tube 116 can be directly welded on the bottom of container 102, as known to those skilled in the art. The two electrical terminals of heating tube 116 extend downward to a predetermined distance and are adapted to removably engage with an electrical power supply, as container 102 is installed in position on base support 112. There are significant advantages of installing heating tube 116 directly on the bottom of container 102. These advantages include saving a significant amount of material for building a separate full heater that has a thermal diffusion plate, resulting in space and cost saving and higher heat transfer efficiency. Other forms of heater designs or heating methods are readily applicable, such as a full heater having a thermal diffusion plate, heated air, an electrical resistance wire, an induction heater, etc., as known to those in the art.

A plurality of co-rotation prevention members 118, at least one, is constructed inside container 102, on the sidewall, for preventing corn kernels from co-rotating with stirrer 114, as stirrer 114 rotates. Members 118 include an elongated member, preferably rib-shaped, that extends generally vertical along the sidewall of container 102. The upper ends of members 118 extend to the upper portion of container 102. Members 118 are preferably disposed substantially dose to handles 106 or 108, such that members 118 would not obstruct food unloading. Members 118 extend inward to a predetermined distance, away from the sidewall of container 102. The predetermined distance is determined based on the size of container 102. Proper clearance between members 118 and stirrer 114 should be maintained. When corn kernels co-rotate with stirrer 114 and run against members 118, as stirrer 114 rotates, kernels at a higher level close to members 118 would be stopped and tumbled down due to gravity, resulting in better mixing or stirring, thereby facilitating heat transfer to and uniform heating of corn kernels. Other configurations of member 118 are readily applicable without departing the spirit of this invention disclosure, as known to those skilled in the art.

A thermo plate 120, made of a material of high thermal conductivity, is fixedly installed on the bottom of container 102, at a location substantially close to heating tube 116, for removably engaging a thermostat 122. Thermostat 122 is installed on base support 112 and engaged with thermo plate 120 for detecting the temperature, as container 102 is installed in position on base support 112. Such temperature is used to control the electrical power to heating tube 116. The upper end of thermostat 122 protrudes upward above the upper surface of base support 112 with pre-loading, e.g., via a spring 122a. Thermostat 122 can be a digital sensor, such as a NTC or PTC, or an adjustable thermostat, or simply a temperature switch, as known to those skilled in the art.

Base Support 112, disposed underneath container 102, is provided for supporting container 102. The upper portion of base support 112 is removably engaged with the inner periphery of the lower portion of support member 110.

A motor 124 is installed inside base support 112 for providing rotation power to stirrer 114. Motor 124 is removablely coupled with a drive shaft 126, as container 102 is installed in position. Drive shaft 126 is threaded through the central aperture on the bottom of container 102. The upper end of shaft 126 is engaged with stirrer 114 and the tower end of shaft 126 is coupled with motor 124 through a coupling device 132. A seal device 130 is provided for sealing off the interface between shaft 126 and the bottom of container 102.

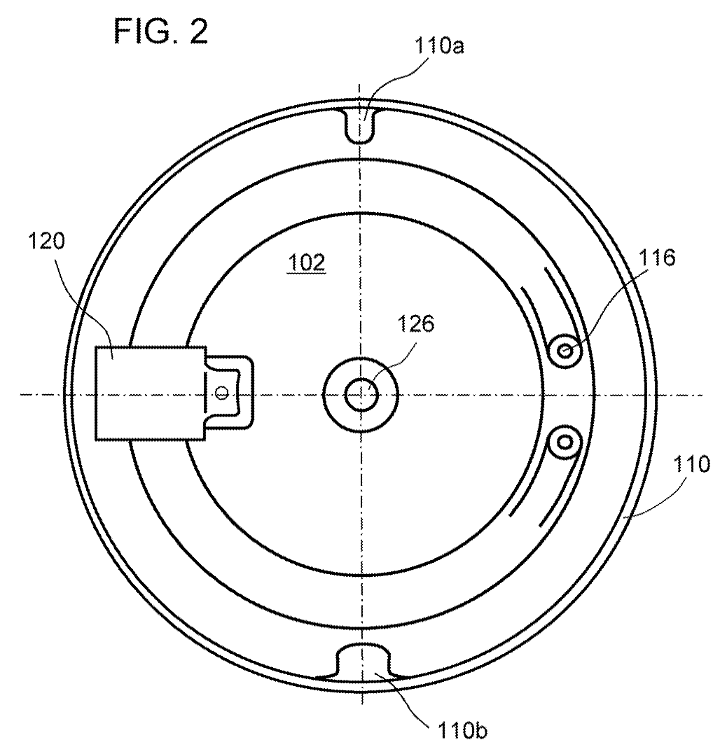

FIG. 2 illustrates a bottom view of container 102 to depict the general layout of various components disposed on the bottom of container 102. Two position guides, generally designated as 110a and 110b, protrude inward a predetermined distance from the inner surface of support member 110 for guiding container 102 in position on base support 112.

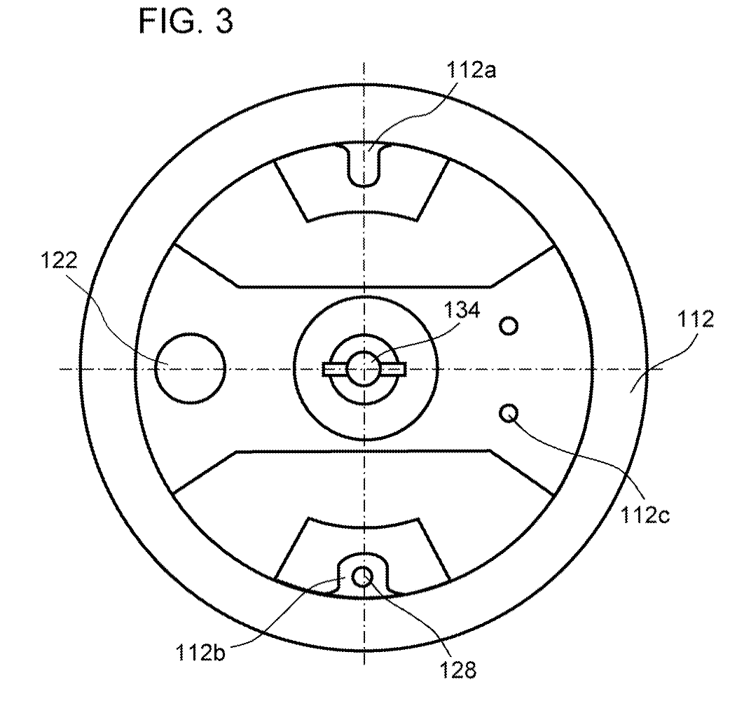

FIG. 3 illustrates a top view of base support 112 to depict the general layout of various components disposed on the top of base support 112. Two base guides, generally designated as 112a and 112b, are provided for removably receiving position guides 110a and 110b respectively. Electrical port 1112c is provided on top of base support 112 for removably receiving the electrical terminals from heating tube 116, such that electrical power from base support 112 is provided to heating tube 116, as container 102 is installed in position on base support 112. An in-position detector 128 is installed on base support 112 for detecting whether container 102 is property installed or not. Detector 128 is disposed at the bottom of base guide 112b. The upper end of detector 128 protrudes a predetermined distance above the bottom of guide 112b, such that when container 102 is installed in position on base support 112, the lower end of position guide 110b would press with a force on detector 128 to confirm that container 102 is well positioned.

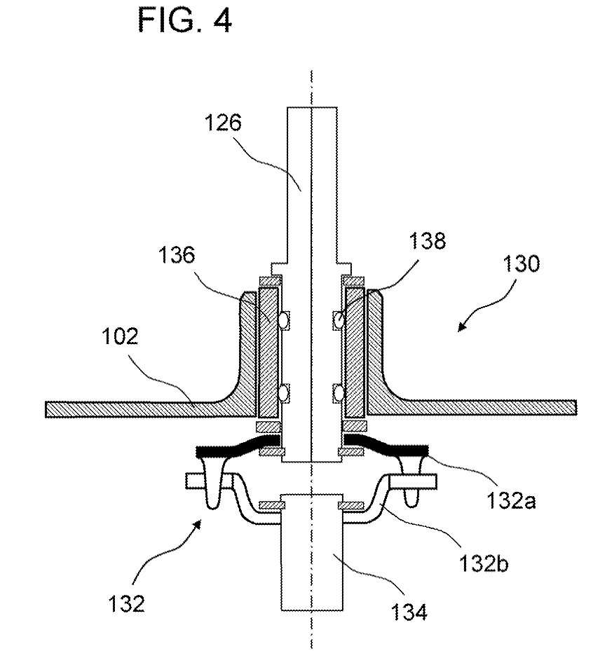

FIG. 4 illustrates an exploded cross-sectional view of seal device 130 and coupling device 132. Seal device 130 comprises a bushing member 136 and a packing member 138. Coupling device 132 includes an upper coupling element 132a; which is engaged with the tower end of shaft 126, and a lower coupling element 132b, which is engaged with a motor shaft 134. Coupling elements 132a and 132b are removably engaged with each other, as container 102 is disposed in position on base support 112.

Bushing 136 is co-axial to shaft 126 and is fixedly and sealingly engaged with the bottom of container 102. Packing 138 is inserted inside a groove cut around shaft 126. A plurality of packing 138 can be provided for more reliable sealing, as known to those skilled in the art. When inserted into bushing 136 together with shaft 126, packing 138 is compressed and squeezed against shaft 126 and bushing 136 to seat off the interface thereof. Bushing 136 extends upward to a predetermined height above the bottom of container 102, such that the upper end of bushing 136 and packing 138 are disposed above the bottom of container 102 and such that the requirement on seal device 130 is significantly reduced. The clearance between bushing 136 and shaft 126 is minimized for ideal sealing performance, but, at the same time, shaft 126 should be able to rotate with minimal friction resistance; which requires high precision of the fitting surfaces thereof.

Materials for packing 138 are extremely important when selecting the proper packing for an application. Basic requirements include heat resistance, wearing resistance, elasticity, etc.

Seal device 130 can, alternatively, take many other forms, such as bushing, labyrinth, packing, or combinations of multiple forms for ideal performance, as known to those skilled in the art and suggested by this invention disclosure.

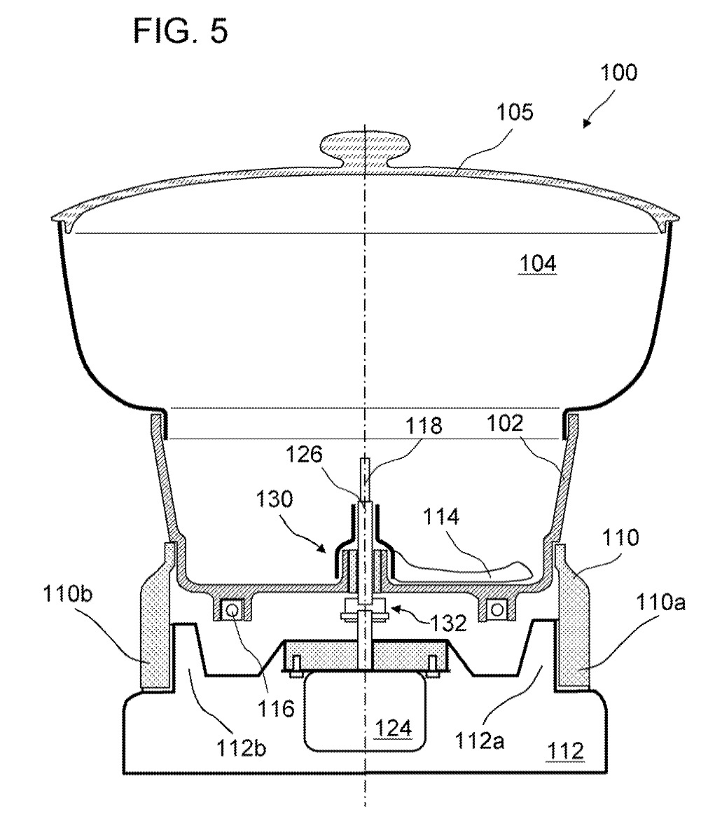

FIG. 5 illustrates another cross-sectional view of popcorn maker 100 to better describe how container 102 is installed on base support 112. Position guides 110a and 110b are inserted into base guides 112a and 112b, respectively, such that container 102 is removably locked in position on base support 112.

Accordingly, as container 102 is property installed in position on base support 112, thermostat 122 is engaged with thermo plate 120, or directly with the bottom of container 102, the electrical terminals of heating tube 116 are connected with electrical port 112c, motor 124 is coupled with shaft 126, and detector 128 is depressed to confirm that container 102 is well in position. Popcorn maker 100 is, now, ready for popping corns.

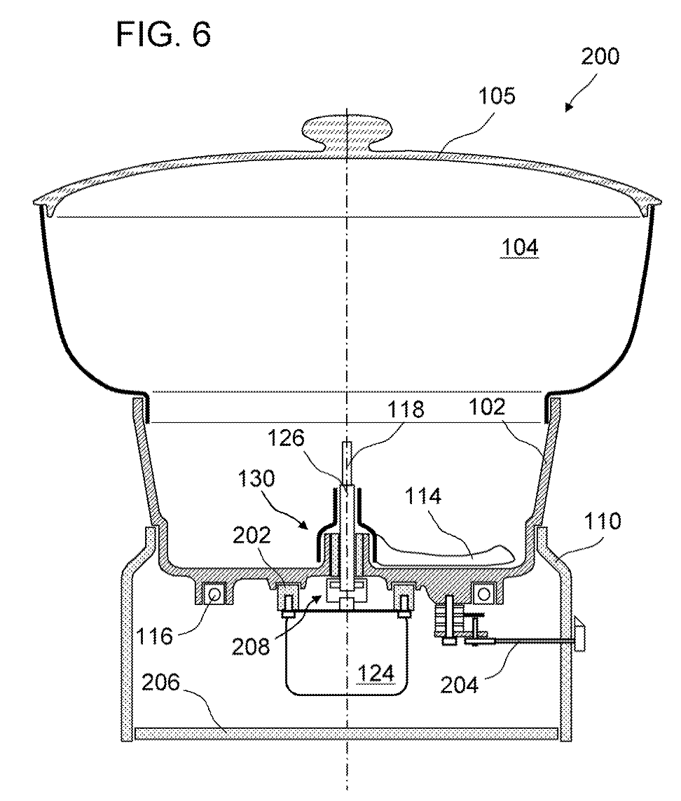

FIG. 6 illustrates a cross-sectional view of another embodiment of the present invention, a popcorn maker 200. Some components or devices of popcorn maker 200 are similar to those of popcorn maker 100. Similarity is in the sense of both functionality and configuration. Therefore, similar components or devices are denoted with similar reference numbers to avoid repetitive explanations. Popcorn maker 200 is a further simplified version of popcorn maker 100.

Motor 124 is directly installed on the bottom of container 102. An insulation member 202 is provided in between motor 124 and the bottom of container 102 for shielding motor 124 away from heat transferred from the bottom of container 102. An adjustable thermostat 204, installed directly on the bottom of container 102, is provided for controlling the temperature of heating tube 116. A bottom cap 206 is provided for closing the bottom opening of support member 110.

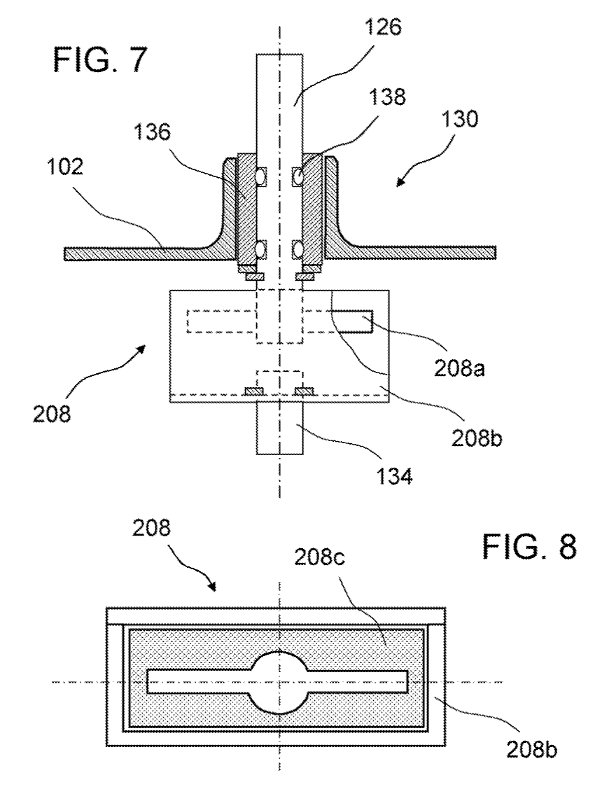

Reference is made to FIG. 7, which illustrates a side view of coupling device 208. Coupling device 208 is provided for coupling motor 124 and drive shaft 126. Coupling device 208 includes an upper coupling element 208a, which is engaged with drive shaft 126, and a lower coupling element 208b, which is engaged with motor shaft 134. An insulation insert 208c, as more clearly shown in FIG. 8, which illustrates a top view of coupling device 208, is provided in between coupling elements 208a and 208b, such that heat transferred from drive shaft 126 is prevented from passing through to motor 124, and whereby motor 124 is not overheated with heat transferred from the bottom of container 102.

In operation, a user adds oil, corn kernels, sugar, spices, etc. into the container 102; installs popping bowl 104 on top of container 102 and disposes container 102 in position on base 112; turns on popcorn maker 100. In about 5 minutes popcorn will be ready for serving. The user can serve the popcorn directly with container 102 and bowl 104, together acting as a serving tray. Both container 102 and bowl 104 are dishwasher safe; which makes popcorn maker 100 convenient for cleaning after use.

Accordingly, readers will see that this popcorn maker of the present invention can be used to make caramel or kettle corns and it is highly compact to save kitchen space and manufacturing cost. The container is removable from the base support such that it is convenient for cleaning after use and dishwasher safe. The popping bowl is used for holding popped corns and acts as a serving bowl. The popcorn maker of the present invention can also be used for making many other treats.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A popcorn maker, said popcorn maker comprising:
a container having an open top and a sidewall for holding and popping corn kernels;
a popping bowl removably installed on top of said container for holding popped corns;
stirring means installed inside said container for stirring corn kernels;
heating means for heating corn kernels disposed inside said container;
a motor installed on the bottom of said container for driving said stirring means;
wherein said motor is coupled with a drive shaft and said drive shaft is coupled with said stirring means;
a support member having two ends for supporting said container; and
wherein the upper end of said support member is fixedly engaged with the periphery of the lower portion of said container and the lower end of said support member extends downward to a predetermined distance, such that said popcorn maker is adapted to stand on a horizontal surface.

2. A popcorn maker as defined in claim 1, wherein said heating means includes a heating tube of a generally circular configuration, said heating tube is fixedly installed on the bottom of said container, and said heating tube is disposed close to the periphery of the bottom of said container with a predetermined distance.

3. A popcorn maker as defined in claim 1, wherein said popping bowl has an open top and an open bottom, has a generally tapered cross-section with a larger diameter facing upward, the lower end of said popping bowl is removably engaged with the upper portion of said container, and wherein said popcorn maker further includes a lid for closing up the open top of said popping bowl.

4. A popcorn maker as defined in claim 1, wherein said container has a central aperture opened on the bottom and includes a seal device installed on the bottom for sealing off the interface between said drive shaft and the central aperture on the bottom of said container, said seal device includes a bushing member fixedly and sealingly engaged with the central aperture on the bottom of said container, said drive shaft is threaded through said bushing member, and at least one packing member is adapted to be squeezed against said drive shaft and said bushing member for sealing off the interface thereof.

5. A popcorn maker as defined in claim 1, wherein said container includes at least one co-rotation prevention member installed on the sidewall of said container for preventing corn kernels from co-rotating with said stirring means, as said stirring means rotates, and wherein said at least one co-rotation prevention member is extended generally vertical along the sidewall of said container, is generally an elongated member, is extended from the lower portion of said container upward to the upper portion of said container, and is extended inward from the sidewall of said container to a predetermined distance, away from the sidewall of said container.

6. A popcorn maker as defined in claim 5, wherein said at least one co-rotation prevention member is disposed substantially close to a grasp handle or a lift handle, such that said at least one co-rotation prevention member does not obstruct corn or food unloading.

7. A popcorn maker as defined in claim 1, said popcorn maker further including a thermostat installed on the bottom of said container for detecting and limiting the temperature of said heating means, such that said heating means and the neighboring components are not overheated and said popcorn maker is adapted for multiple applications of various temperature settings.

8. A popcorn maker as defined in claim 1, wherein said motor is coupled with said drive shaft through a coupling device, and said coupling device includes a insulation member, such that heat transferred from said drive shaft is prevented from passing through to said motor, and whereby said motor is not overheated with heat transferred from the bottom of said container.

9. A popcorn maker as defined in claim 1, wherein said motor is fixedly engaged with a insulation member said insulation member is fixedly installed on the bottom of said container, such that heat transferred from the bottom of said container is prevented from passing through to said motor, and whereby said motor is not overheated with heat transferred from the bottom of said container.

10. A popcorn maker, said popcorn maker comprising:
a container having an open top and a sidewall for holding and popping corn kernels;
a popping bowl removably installed on top of said container for holding popped corns;
stirring means installed inside said container for stirring corn kernels;
heating means for heating corn kernels disposed inside said container;
a base support disposed underneath said container for supporting said container;
a motor installed inside said base support for driving said stirring means;
wherein said motor is removably coupled with a drive shaft and said drive shaft is coupled with said stirring means;
a support member having two ends for supporting said container;
wherein the upper end of said support member is fixedly engaged with the periphery of the lower portion of said container and the lower end of said support member extends downward to a predetermined distance, such that said container is adapted to stand on said base support;
wherein said motor is coupled with said stirring means as said container is disposed in position on said base support;
wherein said heating means is connected with an electrical port on said base support as said container is disposed in position on said base support;
wherein said container together with said support member is removable from said base support; and
whereby said container is convenient for cleaning after use and dishwasher safe.

11. A popcorn maker as defined in claim 10, wherein said heating means includes a heating tube of a generally circular configuration, said heating tube is fixedly installed on the bottom of said container and said heating tube is disposed close to the periphery of the bottom of said container with a predetermined distance.

12. A popcorn maker as defined in claim 10, wherein said popping bowl has an open top and an open bottom, has a generally tapered cross-section with a larger diameter facing upward, the lower end of said popping bowl is removably engaged with the upper portion of said container, and wherein said popcorn maker further includes a lid for closing up the open top of said popping bowl.

13. A popcorn maker as defined in claim 10, wherein said container has a central aperture opened on the bottom and includes a seal device installed on the bottom for sealing off the interface between said drive shaft and the central aperture on the bottom of said container, said seat device includes a bushing member fixedly and sealingly engaged with the central aperture on the bottom of said container, said drive shaft is threaded through said bushing member, and at least one packing member is adapted to be squeezed against said drive shaft and said bushing member for sealing off the interface thereof.

14. A popcorn maker as defined in claim 10, wherein said container includes at least one co-rotation prevention member installed on the sidewall of said container for preventing corn kernels from co-rotating with said stirring means, as said stirring means rotates, and wherein said at least one co-rotation prevention member is extended generally vertical along the sidewall of said container, is generally an elongated member, is extended from the lower portion of said container upward to the upper portion of said container, and is extended inward from the sidewall of said container to a predetermined distance, away from the sidewall of said container.

15. A popcorn maker as defined in claim 14, wherein said at least one co-rotation prevention member is disposed substantially dose to a grasp handle or a lift handle, such that said at least one co-rotation prevention member does not obstruct corn or food unloading.

16. A popcorn maker as defined in claim 10, said popcorn maker further including a thermostat installed inside said base support for detecting and limiting the temperature of said heating means, such that said heating means and the neighboring components are not overheated and said popcorn maker is adapted for multiple applications of various temperature settings.

17. A popcorn maker as defined in claim 16, wherein said thermostat is preloaded with a spring member, the upper end of said thermostat protrudes upward above the upper surface of said base support, and when said container is disposed in position on said base support said thermostat is adapted to be engaged with the bottom of said container.

18. A popcorn maker as defined in claim 16, wherein said thermostat is preloaded with a spring member, a thermo plate is fixedly installed on the bottom of said container at a location substantially close to said heating means, the upper end of said thermostat protrudes upward above the upper surface of said base support, and when said container is disposed in position on said base support said thermostat is adapted to be engaged with said thermo plate.

19. A popcorn maker as defined in claim 10, wherein said support member includes at least one position guide for guiding said container in position on said base support, said base support includes at least one base guide for removably receiving said at least one position guide from said support member, such that said container is guided in position on said base support.

20. A popcorn maker as defined in claim 10, wherein said support member has a generally tapered hollow cylindrical configuration, the upper end of said support member is routed over the lower portion of said container and is fixedly engaged thereof, the lower end of said support member is routed over the upper portion of said base support and is removably engaged thereof, the upper portion of said base support removably receives the lower end of said support member.
